(19) United States
(12) Patent Application Publication
(10) Pub. No.: US 2025/0307110 A1
(43) Pub. Date: Oct. 2, 2025

(54) COMPUTING CLUSTER, AND DATA ACQUISITION METHOD AND APPARATUS FOR SAME, AND STORAGE MEDIUM

(71) Applicant: CLOUD INTELLIGENCE ASSETS HOLDING (SINGAPORE) PRIVATE LIMITED, Singapore (SG)

(72) Inventors: Xiangzheng SUN, Hangzhou, Zhejiang (CN); Wanqing HE, Hangzhou, Zhejiang (CN)

(21) Appl. No.: 18/864,843

(22) PCT Filed: May 11, 2023
(86) PCT No.: PCT/CN2023/093405

§ 371 Date: Nov. 11, 2024

(30) Foreign Application Priority Data
May 17, 2022 (CN) 202210541467.1

(51) Int. Cl. G06F 11/34; G06F 11/30

(52) U.S. Cl. CPC G06F 11/3452; G06F 11/3006

(57) ABSTRACT

Embodiments of the present application provide a computing cluster, and a data acquisition method and apparatus for same, and a storage medium. In the embodiments of the present application, under a computing cluster scenario, acquisition frequencies of performance indicator data is adaptively changed based on change information of the performance indicator data, so that acquisition accuracy can be ensured to guarantee the accuracy of performance analysis based on the performance indicator data and decision-making based on an analysis result, and acquisition and processing overheads of the performance indicator data can also be reduced. In a process of adaptively changing the acquisition frequencies, regarding at least two computing nodes executing a same working task, a primary node among the at least two computing nodes is responsible for adaptive change processing of the acquisition frequencies and synchronizing it to an else computing node when a change is required, and the else computing node is not responsible for the adaptive change processing of the acquisition frequencies, so that the processing burden of the else computing node can be reduced.

### CROSS-REFERENCE TO RELATED APPLICATIONS

This application is a National Stage of International Application No. PCT/CN2023/093405, and filed on May 11, 2023, which claims priority to Chinese Patent Application No. 202210541467.1, filed to the China National Intellectual Property Administration on May 17, 2022 and entitled “COMPUTING CLUSTER, AND DATA ACQUISITION METHOD AND APPARATUS FOR SAME, AND STORAGE MEDIUM”. The disclosures of the aforementioned applications are hereby incorporated by reference in their entireties.

### TECHNICAL FIELD

The present application relates to the field of cloud computing technology and, in particular, to a computing cluster, and a data acquisition method and apparatus for same, and a storage medium.

### BACKGROUND

High Performance Computing (HPC) refers to a computing system and environment in which many processors (as part of a single machine) or several computers organized in a cluster (operating as a single computing resource) are used typically. There are many types of HPC systems, which range from large clusters of standard computers, to highly specialized hardware. Most cluster-based HPC systems use a high-performance network to interconnect computers.

Performance monitoring and performance analysis are indispensable parts for construction of the HPC system. For the HPC system, processing overheads of performance indicator data are a challenge that the HPC system confronts during the performance monitoring and the performance analysis, including data transmission overheads, data processing overheads, data storage overheads and data analysis overheads.

In order to reduce the processing overheads of the performance indicator data, a relatively low acquisition frequency is generally used to reduce the amount of the performance indicator data. However, the relatively low acquisition frequency may cause loss or distortion of performance indicator data, thereby affecting the accuracy of performance analysis results, and hence leading to performance analysis results-based decision errors.

### SUMMARY

Aspects of the present application provide a computing cluster, and a data acquisition method and apparatus for same, and a storage medium, for solving a contradiction problem between processing overheads of performance indicator data and accuracy of performance analysis results, ensuring acquisition accuracy of performance indicators to guarantee accuracy of performance analysis, and meanwhile reducing acquisition and processing overheads of the performance indicator data.

An embodiment of the present application provides a computing cluster, where the computing cluster includes: a management and control node and a plurality of computing nodes, where each computing node is deployed with a plurality of acquisitors, and different acquisitors are configured to acquire different performance indicators; the management and control node is configured to deploy a same working task on at least two computing nodes of the plurality of computing nodes and control the at least two computing nodes to execute the working task; each computing node is configured to initiate at least two target acquisitors correlated with the working task during execution of the working task, to enable the at least two target acquisitors to acquire, at current acquisition frequencies, at least two types of performance indicator data of the computing node in which they are located; when determining that the computing node itself is a primary node in the at least two computing nodes, adjust the acquisition frequencies of the at least two target acquisitors based on change information of the at least two types of performance indicator data; notify an else computing node of the at least two computing nodes to adjust acquisition frequencies of at least two target acquisitors in the else computing node, to enable the at least two target acquisitors in the else computing node to proceed with acquiring, at an adjusted acquisition frequency, the at least two types of performance indicator data of the computing node in which they are located.

An embodiment of the present application further provides a data acquisition method for a computing cluster, where the method includes: initiating, during execution of a working task, at least two target acquisitors correlated with the working task, to enable the at least two target acquisitors to acquire, at current acquisition frequencies, at least two types of performance indicator data of a computing node in which they are located, where the working task is deployed in at least two computing nodes in the computing cluster; adjusting the acquisition frequencies of the at least two target acquisitors based on change information of the at least two types of performance indicator data when determining that the computing node itself is a primary node in the at least two computing nodes; notifying an else computing node of the at least two computing nodes to adjust acquisition frequencies of at least two target acquisitors deployed in the else computing node, to enable the at least two target acquisitors in the else computing node to proceed with acquiring, at an adjusted acquisition frequency, the at least two types of performance indicator data of the computing node in which they are located.

An embodiment of the present application further provides another data acquisition method for a computing cluster, where the method includes: initiating, during execution of a working task, at least two target acquisitors correlated with the working task, to enable the at least two target acquisitors to acquire, at current acquisition frequencies, at least two types of performance indicator data of a computing node in which they are located; dividing the at least two target acquisitors into at least two associated acquisitor groups based on an association of performance indicators that the at least two target acquisitors are responsible for acquiring; separately adjusting an acquisition frequency of a target acquisitor in each associated acquisitor group based on change information of performance indicator data acquired by the target acquisitor in each associated acquisitor group, to enable target acquisitors to proceed with acquiring, at an adjusted acquisition frequency, the at least two types of performance indicator data of the computing node in which they are located.

An embodiment of the present application further provides a data acquisition apparatus, applied to any computing node in a computing cluster, where the apparatus includes: an initiating module, configured to initiate, during execution of a working task, at least two target acquisitors correlated with the working task, to enable the at least two target acquisitors to acquire, at current acquisition frequencies, at least two types of performance indicator data of a computing node in which they are located, where the working task is deployed in at least two computing nodes in the computing cluster; an adjusting module, configured to adjust the acquisition frequencies of the at least two target acquisitors based on change information of the at least two types of performance indicator data when determining that the computing node itself is a primary node in the at least two computing nodes; a notifying module, configured to notify an else computing node of the at least two computing nodes to adjust acquisition frequencies of at least two target acquisitors deployed in the else computing node, to enable the at least two target acquisitors in the else computing node to proceed with acquiring, at an adjusted acquisition frequency, the at least two types of performance indicator data of the computing node in which they are located.

An embodiment of the present application further provides a data acquisition apparatus, applied to any computing node in a computing cluster, where the apparatus includes: an initiating module, configured to initiate, during execution of a working task, at least two target acquisitors correlated with the working task, to enable the at least two target acquisitors to acquire, at current acquisition frequencies, at least two types of performance indicator data of a computing node in which the at least two target acquisitors are located; a dividing module, configured to divide the at least two target acquisitors into at least two associated acquisitor groups based on an association of performance indicators that the at least two target acquisitors are responsible for acquiring; and an adjusting module, configured to separately adjust an acquisition frequency of a target acquisitor in each associated acquisitor group based on change information of performance indicator data acquired by the target acquisitor in each associated acquisitor group, to enable target acquisitors to proceed with acquiring, at an adjusted acquisition frequency, the at least two types of performance indicator data of the computing node in which the at least two target acquisitors are located.

An embodiment of the present application further provides a computing node, applied to a computing cluster, where the computing node includes: a memory and a processor; where the memory is configured to store a computer program; and the processor, coupled with the memory, is configured to execute the computer program for performing steps of the methods described above.

An embodiment of the present application further provides a computer-readable storage medium, storing a computer program which, when executed by a processor, causes the processor to implement steps of the methods described above.

In the embodiments of the present application, under a computing cluster scenario, acquisition frequencies of performance indicator data is adaptively changed based on change information of the performance indicator data, so that acquisition accuracy can be ensured to guarantee the accuracy of performance analysis based on the performance indicator data and decision-making based on an analysis result, and acquisition and processing overheads of the performance indicator data can also be reduced. In a process of adaptively changing the acquisition frequencies, regarding at least two computing nodes executing a same working task, a primary node among the at least two computing nodes is responsible for adaptive change processing of the acquisition frequencies and synchronizing it to an else computing node when a change is required, and the else computing node is not responsible for the adaptive change processing of the acquisition frequencies, so that the processing burden of the else computing node can be reduced.

### BRIEF DESCRIPTION OF DRAWINGS

Accompanying drawings described here are intended to provide further understanding of the present application and constitute a part of the present application. Illustrative embodiments of the present application and descriptions thereof are used to explain the present application, but do not constitute improper limitations to the present application.

FIG. 1a is a schematic structural diagram of a computing cluster according to an exemplary embodiment of the present application.

FIG. 1b is a schematic diagram of a plurality of frequency groups according to an exemplary embodiment of the present application.

FIG. 2 is a schematic flowchart of a data acquisition method for a computing cluster according to another exemplary embodiment of the present application.

FIG. 3 is a schematic flowchart of a data acquisition method for a computing cluster according to yet another exemplary embodiment of the present application.

FIG. 4 is a schematic structural diagram of a data acquisition apparatus according to another exemplary embodiment of the present application.

FIG. 5 is a schematic structural diagram of a data acquisition apparatus according to another exemplary embodiment of the present application.

FIG. 6 is a schematic structural diagram of a computing node according to another exemplary embodiment of the present application.

### DESCRIPTION OF EMBODIMENTS

In order to illustrate objectives, technical solutions and advantages of the present application more clearly, the technical solutions in the present application will be described hereunder clearly and comprehensively with reference to specific embodiments of the present application as well as corresponding accompanying drawings. Apparently, the described embodiments are only a part of embodiments of the present application, rather than all embodiments of the present application. All other embodiments obtained by persons of ordinary skill in the art based on the embodiments of the present application without any creative effort shall fall into the scope claimed in the present application.

The technical solutions provided in the embodiments of the present application will be described in details in conjunction with the accompanying drawings.

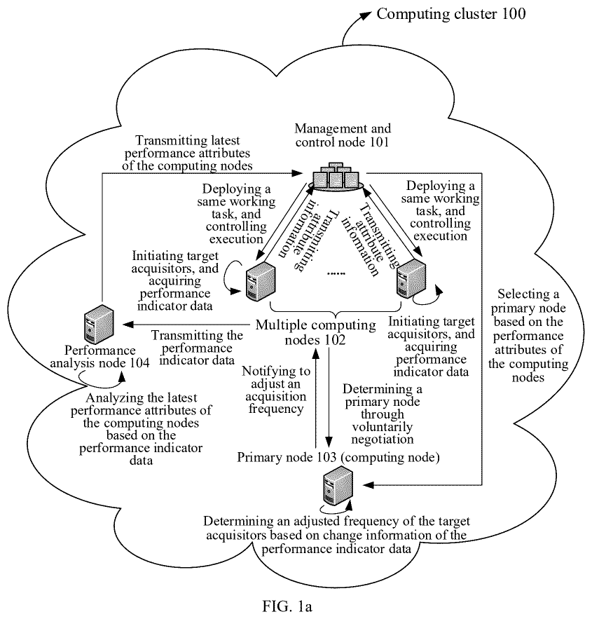

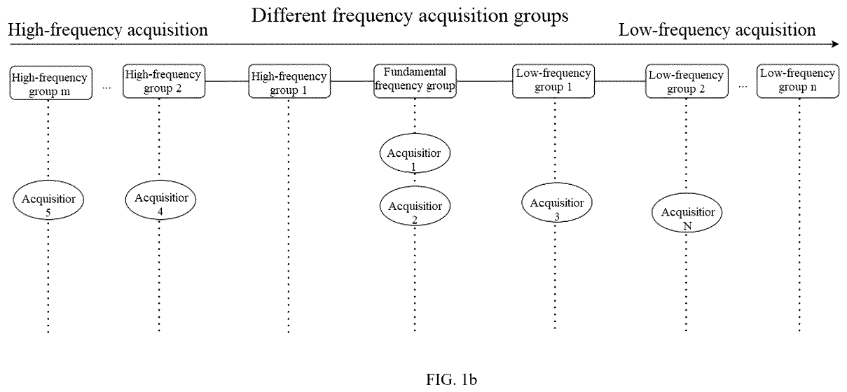

FIG. 1a is a schematic structural diagram of a computing cluster 100 according to an exemplary embodiment of the present application. The computing cluster 100 of the present embodiment can be implemented as a large-scale computing platform, or an HPC system, or one or more computer rooms, or an Internet data center (IDC), or a cloud computing system, or the like. A specific implementation form of the computing cluster 100 is not limited in the present embodiment. As shown in FIG. 1a, the computing cluster 100 includes: a management and control node 101 and a plurality of computing nodes 102. Communication connections can be achieved between the management and control node 101 and the plurality of computing nodes 102, and between the plurality of computing nodes 102.

In the present embodiment, the aforementioned communication connections may be wired or wireless communication connections. In an implementation, in the case of wireless communication connections, respective nodes can be connected in a communication way through a mobile network and, correspondingly, the mobile network may have any one of the following network standards: 2G (GSM), 2.5G (GPRS), 3G (WCDMA, TD-SCDMA, CDMA2000, UTMS), 4G (LTE), 4G+ (LTE+), 5G, WiMax, or a new network standard that will appear in the future. In an implementation, the respective nodes can also be located in a same local area network, and then in the case of wireless communication connections, the respective nodes can also be connected in a communication way by means of Bluetooth, WiFi, infrared, ZigBee, NFC, or the like.

Implementation forms of the management and control node 101 and the computing nodes 102 are not limited in the present embodiment. The management and control node 101 can be implemented in a variety of forms, for example, being deployed in a virtual machine, a cloud server, a cloud host, or a physical machine. In an implementation, the management and control node 101 can be centrally deployed in a physical machine or a virtual machine, or can be distributed in a plurality of physical machines or a plurality of virtual machines, and limitations are not made thereto. Correspondingly, the computing nodes 102 can be in any device form with certain computing power and communication capabilities, for example, they can be virtual machines, physical machines (such as servers, computer devices), cloud servers, cloud hosts, virtual centers, server arrays, or databases.

On the one hand, the management and control node 101 can provide a human-machine interaction interface for a user, and receive a working task submitted by the user through the human-machine interaction interface; on the other hand, it can carry out various types of management and control on the computing cluster 100, for example, deploying a working task across the plurality of computing nodes 102, controlling each computing node 102 to execute the working task, and managing the task execution status of each computing node 102. In practical application, one working task can be deployed in one computing node 102 or deployed in at least two computing nodes 102, depending on the type and performance requirements of the working task. For a working task with a large amount of computations or high requirements for computing efficiency, it can be deployed in at least two computing nodes 102 simultaneously, and executed concurrently by the at least two computing nodes 102 to improve computing efficiency. Based on this, the management and control node 101 can be specifically configured to deploy a same working task on at least two computing nodes 102 of a plurality of computing nodes 102 and control the at least two computing nodes 102 to execute the working task. Where the working task may be deployed in the computing nodes 102 in a manner of, but not limited to: issuing data related to the working task to the computing nodes 102, or issuing a task instruction to the computing nodes 102, where the task instruction carries identification information of the working task therein, and the computing nodes 102 acquire, from a task database, the data related to the working task based on the identification information of the working task. Where the computing nodes 102 may be controlled to execute the working task in a manner of, but not limited to: transmitting an initiation instruction to the computing nodes 102 to instruct the computing nodes 102 to start execution of the working task; or issuing a work instruction parameter to the computing nodes 102, where the work instruction parameter includes an execution time of the working task, for example, initiating the working task 10 minutes later, or initiating the working task at a specified time, particularly at xx (hour):xx (minute), etc.

In the present embodiment, each computing node 102 acts as a task execution node to receive the working task deployed by the management and control node 101 and execute the working task under control from the management and control node 101. In addition, each computing node 102 is deployed with a plurality of acquisitors, each acquisitor is responsible for acquiring one type of performance indicator data, and different acquisitors are responsible for acquiring different performance indicator data. The acquisitor can be a kind of program codes having a data acquisition function, and in terms of its implementation form, it can be a plug-in or an SDK relying on a main program, or an independent software function module, and limitations are not made thereto. Each acquisitor can perform an acquisition operation in connection with performance indicator data according to a certain acquisition frequency, and the amount of performance indicator data is directly related to the magnitude of the acquisition frequency; where, the higher the acquisition frequency is, the more the acquired performance indicator data is, and the higher the accuracy of performance analysis and performance monitoring based on the performance indicator data is, and in turn, the larger the data transmission, storage and computing overheads are; the lower the acquisition frequency is, the less the acquired performance indicator data is, and the lower the accuracy of performance analysis and performance monitoring based on the performance indicator data is, and in turn, the smaller the data transmission, storage, and computing overheads are.

Based on the foregoing descriptions, in addition to executing a working task under control from the management and control node 101, each computing node 102 in the present embodiment may initiate, during execution of the working task, at least two acquisitors correlated with the working task, to enable the initiated at least two acquisitors to acquire at least two types of performance indicator data at a current acquisition frequency. For ease of description and distinguishment, the at least two acquisitors correlated with the working task and initiated by the computing node 102 during execution of the working task are termed as target acquisitors, and the number of target acquisitors is at least two. The target acquisitors initiated for different working tasks may be different, depending on requirements by the working tasks for performance indicators.

The performance indicator data in the present embodiment includes, but is not limited to: a CPU utilization rate of the computing node 102, a memory utilization rate, remaining memory, network bandwidth size, the amount of CPU resources occupied by the working task, the amount of memory resources occupied by the working task, the amount of bandwidth resources consumed by the working task, and so on. Based on the performance indicator data, performance analysis and performance monitoring can be performed from the dimensions of the computing node 102 and/or the working task. For example, based on these pieces of performance indicator data, the performance attributes of the computing node 102 can be analyzed or monitored, and the performance attributes that can be analyzed or monitored include but not limited to: task load, network status and the amount of currently available resources, where the amount of currently available resources includes, at least, remaining CPU or memory of the computing node 102; furthermore, the management and control node 101 can acquire these performance attributes of the computing node 102 and determines, based on these performance attributes, whether it can proceed with assigning a new working task to the computing node 102 and whether there is a need to dynamically adjust the amount of resources of the computing node 102, for example, increasing CPU resources or network bandwidth resources. For example, based on the performance indicator data, it is possible to analyze or monitor running status and resource consumption of the working task, as well as the quality of service (QOS) corresponding to the working task. Furthermore, the management and control node 101 can acquire the running status and the resource consumption of the working task as well as the QoS corresponding to the working task, and determine, based on these pieces of information, whether there is a need to add or decrease the computing node 102 for the working task, so that the node resources can be reasonably utilized to the greatest extent when the running status and the QoS of the working task are guaranteed.

Based on the foregoing analysis, as shown in FIG. la, the computing cluster of the present embodiment further includes a performance analysis node 104, and a communication connection of the performance analysis node 104 with the management and control node 101 and the plurality of computing nodes is implemented. Reference can be made to the forging descriptions for the communication connection mode, and details will not be described here again. In the present embodiment, the performance analysis node 104 is responsible for receiving the performance indicator data reported by each computing node 102, and performs performance analysis and performance monitoring on the computing node 102 and/or the working task based on the performance indicator data reported by each computing node 102. The performance analysis and performance monitoring are necessary parts of protective maintenance for the computing cluster 100, which are convenient for operational personnel to get knowledge of the operation status of the entire cluster and observe the resource utilization efficiency of the cluster.

Specifically, based on the performance indicator data reported by each computing node 102, the performance analysis node 104 can analyze or monitor performance attributes of the computing node 102, where the performance indicator data includes, such as, the CPU utilization rate of each computing node 102, the memory utilization rate, remaining memory and network bandwidth size, and the performance attributes that can be analyzed or monitored include but are not limited to: a task load, a network status, and the amount of currently available resources, etc., and provide the performance attributes of each computing node 102 to the management and control node 101 for a further decision therefrom. And/or, based on the performance indicator data reported by each computing node 102, such as the CPU utilization rate of each computing node 102, the memory utilization rate, the amount of CPU resources occupied by the working task, the amount of memory resources, and bandwidth resources consumed, the performance analysis node 104 can analyze or monitor performance data such as running status and resource consumption of the working task as well as QoS corresponding to the working task, and provide various types of performance data of the working task to the management and control node 101 for a further decision therefrom. For example, the management and control node 101 can analyze a behavioral characteristic of the working task during runtime, and make relatively good resource configurations for the working task based on the behavioral characteristic of the working task during the runtime, where these resource configurations at least include the number of computing nodes 102 and resources such as the CPU in each computing node 102, the memory, and the network.

Based on the foregoing descriptions, for a situation of deploying a same working task in at least two computing nodes 102, based on at least two types of performance indicator data reported by the at least two computing nodes 102 respectively, the performance analysis node 104 can be specifically configured to analyze and obtain latest performance attributes of the at least two computing nodes 102, and provide the latest performance attributes to the management and control node 101 for a further decision therefrom, so that a closed loop in terms of performance management and control is formed for the entire computing cluster.

In an embodiment of the present application, each computing node 102 can execute a working task, and can initiate, during execution of the working task, at least two target acquisitors correlated with the working task, to enable the at least two target acquisitors to acquire, at a current acquisition frequency, at least two types of performance indicator data of a computing node 102 to which they are located. In addition, during a process where the at least two target acquisitors acquire the performance indicator data, based on change information of the performance indicator data, each computing node 102 can also adaptively change the acquisition frequency used by the at least two target acquisitors to acquire the performance indicator data, so that it is convenient to achieve frequency-converted acquisition of the performance indicator data, which not only can ensure acquisition accuracy to guarantee accuracy of performance analysis and decision-making based on the performance indicator data, but also can reduce acquisition and processing overheads of the performance indicator data.

In the present embodiment, since the at least two target acquisitors in each computing node 102 may need to carry out frequency conversion processing during the acquisition, if each computing node 102 performs acquisition frequency calculation and adjustment for its respective at least two target acquisitors separately, the data processing is of large quantity, both time-consuming and laborious, especially in a supercomputing scenario, there are a significant number of computing nodes 102 and target acquisitors, and thus the amount of computations will be relatively large, thereby affecting the overall performance of the computing nodes 102. In order to reduce the amount of data processing caused by dynamically adjusting the acquisition frequency and improve the adjustment efficiency for the frequencies of the target acquisitors, in an embodiment of the present application, for at least two computing nodes 102 deployed with a same working task, a primary node 103 can be selected therefrom; and based on change information of at least two types of performance indicator data of the primary node 103 acquired by the at least two target acquisitors in the primary node 103, the primary node 103 adjusts the acquisition frequencies of the at least two target acquisitors, and notifies an else computing node 102 of the at least two computing nodes 102 to adjust acquisition frequencies of at least two target acquisitors in the else computing node 102, so that at least two target acquisitors in each computing node 102 can proceed with acquiring at least two types of performance indicator data at an adjusted acquisition frequency. It should be noted that the at least two target acquisitors in each computing node are responsible for acquiring at least two types of performance indicator data of the computing node where they are located. In this process, only the primary node 103 is responsible for performing a data processing operation related to acquisition frequency adjustment, whereas the else computing node 102 does not need to perform the data processing operation related to acquisition frequency adjustment and can directly adjust the acquisition frequencies of the at least two target acquisitors in the else computing node 102 based on a notification from the primary node 103, so that the amount of data processing caused by dynamically adjusting the acquisition frequencies can be reduced, and the adjustment efficiency for the acquisition frequencies of the target acquisitors can also be improved.

In the foregoing or the following embodiments of the present application, each computing node 102 initiates at least two target acquisitors correlated with a working task during execution of the task, and a specific implementation is as follows: based on at least two performance indicators correlated with the task executed by each computing node itself, determining at least two target acquisitors corresponding to the at least two performance indicators; then based on identification information of the above-described at least two target acquisitors that is stored locally, transmitting an initiation instruction to at least two corresponding target acquisitors; and after receiving the initiation instruction, starting, by the at least two target acquisitors, to run and acquire corresponding performance indicator data.

Furthermore, the at least two acquisitors transmit the acquired performance indicator data to the computing node 102 where they are located, and the computing node 102 will adjust acquisition frequencies of the at least two target acquisitors based on change information of at least two types of performance indicator data acquired by the at least two target acquisitors. Since the respective target acquisitors may correspond to a same or similar acquisition frequency during execution of a same working task, in order to reduce the amount of tasks for respective computing nodes 102 to adjust the acquisition frequencies of the respective target acquisitors, a computing node 102 can be selected from the at least two computing nodes 102 as a primary node 103, and the primary node 103 determines an adjusted acquisition frequency based on the change information of the at least two types of performance indicator data acquired by the at least two target acquisitors in the primary node 103. On the one hand, it adjusts the acquisition frequencies of the at least two target acquisitors that are local, on the other hand, it notifies an else computing node 102, and based on the notification, the else computing node 102 directly adjusts the acquisition frequencies used by at least two target acquisitors in the else computing node 102. Based on this, for at least two computing nodes 102 executing a same working task, each computing node 102 also needs to determine whether it is the primary node 103; and when determining that it is the primary node 103, based on the change information of the at least two types of performance indicator data acquired by the at least two local target acquisitors, each computing node 102 adjusts the acquisition frequencies of the at least two target acquisitors, and notifies the else computing node 102 of the at least two computing nodes 102 to adjust the acquisition frequencies of the at least two target acquisitors in the else computing node 102. Further, for each computing node 102, when it is determined that the computing node 102 is not the primary node 103, it may wait for the notification from the primary node 103. Before receiving the notification from the primary node 103, the at least two target acquisitors acquire, at the current acquisition frequencies, the at least two types of performance indicator data of the computing node where they are located. After receiving the notification from the primary node 103, the computing node 102 adjusts the acquisition frequencies of the at least two local target acquisitors, and the at least two target acquisitors proceed with acquiring, at an adjusted acquisition frequency, the at least two types of performance indicator data of the computing node where they are located.

A selection mode of the primary node 103 is not limited in an embodiment of the present application, which can be but not limited to the following.

Mode A1: the primary node 103 is selected by the management and control node 101. Specifically, the management and control node 101 is further configured to: select the primary node 103 from the at least two computing nodes 102 based on attribute information of the at least two computing nodes 102 and transmit a notification message to the primary node 103. For at least two computing nodes 102 executing a same working task, based on whether the notification message transmitted by the management and control node 101 is received, each computing node 102 may determine whether the computing node 102 itself is a primary node 103, where each computing node 102 may determine that the computing node 102 itself is the primary node 103 if the notification message is received, and determine that the computing node 102 itself is not the primary node 103 if the notification message is not received.

In the present embodiment, the at least two computing nodes 102 might execute one or more working tasks, and different working tasks may vary in terms of workload magnitude, network bandwidth required, and the amount of resources used. Based on this, an implementation for the management and control node 101 to select the primary node 103 from the at least two computing nodes 102 based on the attribute information of the at least two computing nodes 102 is as follows: selecting the primary node 103 from the at least two computing nodes 102 based on at least one performance attribute among task load, network status and the amount of available resources of the at least two computing nodes 102, where the task load represents load magnitude of the task executed by the computing nodes 102; the network status represents network bandwidth size of the computing nodes 102 during execution of the task, and the amount of available resources represents current remaining CPU and memory of the computing nodes 102.

In an embodiment, when selecting the primary node 103 from the at least two computing nodes 102, several specific implementations are as follows: selecting the primary node 103 from the at least two computing nodes 102 based on the task load of the at least two computing nodes 102; or, selecting the primary node 103 from the at least two computing nodes 102 based on the network status of the at least two computing nodes 102; or, selecting the primary node 103 from the at least two computing nodes 102 based on the amount of available resources of the at least two computing nodes 102; or, selecting the primary node 103 from the at least two computing nodes 102 based on the task load and the network status of the at least two computing nodes 102; or, selecting the primary node 103 from the at least two computing nodes 102 based on the task load and the amount of available resources of the at least two computing nodes 102; or, selecting the primary node 103 from the at least two computing nodes 102 based on the network status and the amount of available resources of the at least two computing nodes 102; or, selecting the primary node 103 from the at least two computing nodes 102 based on the task load, the network status and the amount of available resources of the at least two computing nodes 102.

Further, continuing from the foregoing embodiments, when selecting the primary node 103 from the at least two computing nodes 102 based on the task load of the at least two computing nodes 102, the computing node 102 with a small task load is taken as the primary node 103; when selecting the primary node 103 from the at least two computing nodes 102 based on the network status of at least two computing nodes 102, the computing node 102 with good network status is selected as the primary node 103; when selecting the primary node 103 from the at least two computing nodes 102 based on the amount of available resources of the at least two computing nodes 102, the computing node 102 with a high amount of available resources is selected as the primary node 103; when selecting the primary node 103 from the at least two computing nodes 102 based on the task load and the network status of the at least two computing nodes 102, the computing node 102 with a small task load and good network status is selected as the primary node 103; when selecting the primary node 103 from the at least two computing nodes 102 based on the task load and the amount of available resources of the at least two computing nodes 102, the computing node 102 with a small task load and a high amount of available resources is selected as the primary node 103; when selecting the primary node 103 from the at least two computing nodes 102 based on the network status and the amount of available resources of the at least two computing nodes 102, the computing node 102 with good network status and a high amount of available resources is selected as the primary node 103; or, when selecting the primary node 103 from the at least two computing nodes 102 based on the task load, the network status and the amount of available resources of the at least two computing nodes 102, the computing node 102 with a small task load, good network status and a high amount of available resources is selected as the primary node 103.

It should be noted that the foregoing method of determining the primary node 103 from the at least two computing nodes 102 is only illustrative, but not limited thereto.

Further, in the present embodiment, considering that the performance attributes of the primary node 103 may change dynamically, in order to facilitate the improvement of the execution efficiency of dynamically adjusting the acquisition frequency, dynamical replacement of a new primary node 103 may be performed. Based on this, based on the at least two types of performance indicator data reported by the at least two computing nodes 102 respectively, the performance analysis node 104 can analyze and obtain latest performance attributes of the at least two computing nodes 102, and provide them to the management and control node 101; and the management and control node 101 is further configured to make a reselection for a new primary node 103 from the at least two computing nodes 102 based on the latest performance attributes of the at least two computing nodes 102 and transmit a notification message to the new primary node 103. Furthermore, after the new primary node 103 receives the notification message, there is possibly an automatic transition to the new primary node 103. Furthermore, the management and control node 101 can also transmit indication information of transitioning to a non-primary node 103 to the original primary node 103, and the original primary node 103 disables the function of the primary node 103 when receiving the indication information. It should be noted that FIG. 1a shows a manner in which the management and control node 101 selects the primary node 103 and makes dynamical update to the primary node 103.

Mode A2: in addition to that the management and control node 101 selects the primary node 103 from the at least two computing nodes 102, the computing nodes 102 can determine a primary node 103 through voluntarily negotiation according to a set mode for selecting the primary node 103. A specific implementation is as follows: for each computing node 102 executing the same working task, the computing node 102 can determine whether it is the primary node 103 based on specified attribute information of the at least two computing nodes 102 (that is, the computing node 102 itself and the else computing node(s) 102) in combination with a preset condition that should be satisfied to select the primary node 103 based on the specified attribute information. The specified attribute information may be device numbers or IP addresses of the computing nodes 102, and the condition that should be met to select the primary node 103 based on the specified attribute information may be that the node with the largest device number or the largest IP address acts as the primary node 103, or the node with the smallest device number or the largest IP address acts as the primary node 103. Based on this, a manner in which the computing node determines whether it is the primary node 103 based on the device numbers or the IP addresses of the at least two computing nodes 102 in combination with the preset condition that should be satisfied to select the primary node 103 based on the specified attribute information includes: each computing node 102 compares its own device number or IP address with a device number or an IP address of an else computing device; if the device number or the IP address of the computing node 102 is the largest, it is determined that the computing node 102 itself is the primary node 103, otherwise it is determined that the computing device 102 itself is not the primary node 103. In another embodiment, each computing node 102 compares its own device number or IP address with a device number or an IP address of an else computing device; if the device number or the IP address of the computing node 102 is the smallest, it is determined that the computing node 102 itself is the primary node 103, otherwise it is determined that the computing node 102 itself is not the primary node 103. It should be noted that FIG. la also shows a manner that the computing nodes 102 determine the primary node 103 through voluntarily negotiation.

In the foregoing or the following embodiments of the present application, based on the change information of the at least two types of performance indicator data acquired by the at least two target acquisitors that are local, the primary node 103 can adjust the acquisition frequencies of the at least two target acquisitors. A specific implementation is as follows: firstly, dividing the at least two target acquisitors into at least two associated acquisitor groups based on an association of performance indicators that the at least two target acquisitors are responsible for acquiring; in units of associated acquisitor groups, separately adjusting an acquisition frequency of a target acquisitor in each associated acquisitor group based on change information of performance indicator data acquired by the target acquisitor in each associated acquisitor group. In the present embodiment, the acquisitors are grouped, and acquisition frequency adjustment is uniformly performed on acquisitors with a strong association in units of groups, that is, for target acquisitors in a same associated acquisitor group, they have a same adjusted acquisition frequency, which is conducive to further simplifying the computing resources consumed by adjusting acquisition frequencies and improving the overall adjustment efficiency of the acquisition frequencies.

In an embodiment, target acquisitors whose association of performance indicators that the at least two target acquisitors are responsible for acquiring is greater than a preset threshold can be divided into at least two associated acquisitor groups. For example, a target acquisitor configured to acquire a CPU utilization rate and a target acquisitor configured to acquire CPU floating-point operation efficiency can be divided into a same associated acquisitor group, a target acquisitor configured to acquire a memory utilization rate and a target acquisitor configured to acquire read/write bandwidth resources can be divided into a same associated acquisitor group, and a target acquisitor configured to acquire bandwidth resources for network reception/transmission and a target acquisitor configured to acquire a packet rate for network reception/transmission are divided into a same associated acquisitor group, but limitations are not made thereto.

Further, in an embodiment, for each associated acquisitor group, before adjusting an acquisition frequency of a target acquisitor in each associated acquisitor group, it may determine whether current acquisition frequencies of respective target acquisitors in the associated acquisitor group are the same, if they are not the same, the current acquisition frequencies of the respective target acquisitors in the associated acquisitor group are adjusted to a same acquisition frequency. The current acquisition frequencies refer to acquisition frequencies currently used by the respective target acquisitors.

Continuing from the foregoing embodiments, when the current acquisition frequencies of the respective target acquisitors in the associated acquisitor group are different, the current acquisition frequencies of the respective target acquisitors in the associated acquisitor group can be adjusted to a same acquisition frequency by using the following implementations: adjusting each of the current acquisition frequencies of the respective target acquisitors in the associated acquisitor group to an average value of the current acquisition frequencies of the respective target acquisitors in the associated acquisitor group; or adjusting each of the current acquisition frequencies of the respective target acquisitors in the associated acquisitor group to a maximum acquisition frequency among the current acquisition frequencies of the respective target acquisitors in the associated acquisitor group; or adjusting each of the current acquisition frequencies of the respective target acquisitors in the associated target acquisitor to a minimum acquisition frequency among the current acquisition frequencies of the respective target acquisitors in the associated acquisitor group. The foregoing manner in which the current acquisition frequencies of the respective target acquisitors in the associated acquisitor group are adjusted to the same acquisition frequency is only illustrative, but limitations are not made thereto.

Similarly, continuing from the foregoing embodiments, after adjusting the current acquisition frequencies of the respective target acquisitors in the associated acquisitor group to the same acquisition frequency, an acquisition frequency of a target acquisitor in each associated acquisitor group is adjusted respectively based on change information of performance indicator data acquired by the target acquisitor in each associated acquisitor group, and a specific implementation thereof is as follows: determining, for each associated acquisitor group, a frequency conversion direction corresponding to the associated acquisitor group based on the change information of the performance indicator data acquired by the target acquisitor in the associated acquisitor group; then adjusting the acquisition frequency currently used by the target acquisitor in the associated acquisitor group to a closest preset frequency of a plurality of preset frequencies in the frequency conversion direction, where the plurality of preset frequencies are from small to large. In the present embodiment, the frequency conversion direction includes frequency-increasing, frequency-decreasing and frequency-remaining-unchanged, but limitations are not made thereto. The frequency conversion granularity of the frequency-increasing and the frequency-decreasing can also be refined, to obtain more frequency conversion directions. In the present embodiment, a plurality of frequencies are preset, and the plurality of preset frequencies are from small to large, which are not the same. Assuming that the plurality of preset frequencies are f1, f2, f3, f4 and f5 from small to large, and assuming that the current acquisition frequency is f2 and the frequency conversion direction is frequency-increasing, then the closest preset frequency of the plurality of preset frequencies in the frequency conversion direction refers to frequency f3; likewise, when the frequency conversion direction is frequency-decreasing, the closest preset frequency of the plurality of preset frequencies in the frequency conversion direction refers to frequency f1.

In the foregoing embodiments, a plurality of frequency groups are preset, and each frequency group corresponds to a preset frequency, where these preset frequencies rank from small to large, and each frequency group are arranged from large to small orderly based on acquisition frequencies. As shown in FIG. 1b, the following frequency groups are included, such as a high-frequency group m to a high-frequency group 1, a fundamental frequency group, and a low-frequency group 1 to a low-frequency group n; where m and n are positive integers. For the primary node 103, at the beginning, the at least two target acquisitors can be initialized to correspond to a fundamental frequency, and these target acquisitors can be uniformly added to the fundamental frequency group for management; then, the at least two target acquisitors are divided into different associated acquisitor groups based on an association of performance indicators that the target acquisitors are responsible for acquiring, and in units of associated acquisitor groups, for each associated acquisitor group, a frequency conversion direction corresponding to the associated acquisitor group is determined based on the change information of the performance indicator data acquired by the target acquisitor in the associated acquisitor group; based on the frequency conversion direction, the target acquisitor in the associated acquisitor group is adjusted from the current frequency group to a closest frequency group in the frequency conversion direction.

Specifically, for an associated acquisitor group of which the frequency conversion direction is frequency-increasing, a target acquisitor in the associated acquisitor group is moved from the fundamental frequency group to the high-frequency group 1; for an associated acquisitor group of which the frequency conversion direction is frequency-decreasing, a target acquisitor in the associated acquisitor group is moved from the fundamental frequency group to the low-frequency group 1; for an associated acquisitor group of which the frequency conversion direction is frequency-remaining-unchanged, a target acquisitor in the associated acquisitor group remains in the fundamental frequency group. With the passage of time, the frequency group of the target acquisitor(s) in each associated acquisitor group can be continuously adjusted in a similar frequency conversion manner, and for a target acquisitor in a certain frequency group, a preset frequency corresponding to the frequency group of the target acquisitor can be used to acquire performance indicator data.

In an embodiment, for each associated acquisitor group, the frequency conversion direction corresponding to the associated acquisitor group is determined based on the change information of the performance indicator data acquired by the target acquisitor in the associated acquisitor group, and a specific implementation is as follows: firstly, for each associated acquisitor group, acquiring key performance indicator data acquired by a key acquisitor in the associated acquisitor group, where the key acquisitor is a target acquisitor responsible for acquiring a key performance indicator, and the key indicator data is some of indicator data that can be acquired by each target acquisitor in the associated acquisitor group, for example, the key performance indicator data can be one or more pieces of indicator data with highest importance; then, performing a statistical analysis on change rates of respective pieces of key performance indicator data based on a set statistical interval, and generating a global change rate based on the change rates of the respective pieces of key performance indicator data; further, determining the frequency conversion direction corresponding to the associated acquisitor group based on the global change rate, where the frequency conversion direction corresponding to the associated acquisitor group can be any one of frequency-increasing, frequency-decreasing and frequency-remaining-unchanged.

When performing a statistical analysis on the change rates of the respective pieces of key performance indicator data, the change rates of the respective pieces of key performance indicator data within the statistical interval can be obtained through the statistical analysis based on the set statistical interval, and the statistical interval is not limited in the present embodiment. An acquisition period corresponding to the current acquisition frequency of the target acquisitor can be taken as the statistical interval, for example, the acquisition period corresponding to the current acquisition frequency is 1 s, then the statistical interval is 1 s, that is, one piece of key performance indicator data is acquired per 1 s, and the change rate of the key performance indicator data acquired in two adjacent times is calculated. Alternatively, a plurality of acquisition periods can be taken as the statistical interval, for example, 10 acquisition periods can be taken as the statistical interval, that is, the statistical interval is 10 s, then the change rate of the key performance indicator data is calculated once per 10 seconds, and the change rate of the key performance indicator data within 10 seconds can be calculated based on ten times of key performance indicator data acquired in the 10 seconds.

For ease of description, Pi is used to represent a respective key performance indicator, and Δ(Pi) represents variation in performance values of the key indicator Pi at two adjacent statistical intervals, and different weights are given to different key performance indicators, indicated by (W1, W2 . . . Wn), where Wi represents a weight of an i-th key performance indicator, then a global change rate generated based on change rates of respective pieces of key performance indicator data can be expressed as: Σᵢ₌₀ⁿΔPi*Wi. It should be noted that a statistical threshold of each key performance indicator will be set in the present embodiment, and the statistical threshold is indicated by (PT1, PT2, . . . PTn), where PTi represents a minimal change threshold of the i-th key performance indicator. Based on this, a determination can be made with regard to whether the variation of each key performance indicator exceeds the threshold in a determination period. If the variation exceeds the threshold, the change rate of the respective piece of key performance indicator data is obtained through the statistical analysis, otherwise, if the variation of the key performance indicator data of two adjacent periods does not exceed the corresponding threshold, it means that the key performance indicator data changes insignificantly, and the change direction can be directly set to 0, indicating that there is no need for frequency adjustment, that is, the frequency conversion direction remains unchanged.

When the change rates of the respective pieces of key performance indicator data are obtained through the statistical analysis, the global change rate is generated based on the above weighted summation formula. Further, the frequency conversion direction corresponding to the associated acquisitor group is determined based on the global change rate by using the frequency conversion strategy, and a specific implementation is as follows: taking the global change rate as an input of the frequency conversion strategy, and determining the frequency conversion direction corresponding to the associated acquisitor group based on an output value. When the output value is 0, it means that there is no need to change the frequency of the target acquisitor; when the output value is 1, it means that that the acquisition frequency of the target acquisitor needs to be increased; and when the output value is −1, it means that the acquisition frequency of the target acquisitor needs to be decreased. Further, in an implementation, the output value is determined by using the frequency conversion strategy, and a specific implementation is as follows: calculating a weighted change rate of the key indicator data in the associated acquisitor group, for ease of description, KeyDelta is used to represent the weighted change rate of the key indicator data, and upper and lower limits of a change rate threshold are (β1, β2), where β1≤β2, when KeyDelta>β2, the acquisition frequency needs to be increased, and the output value is 1; when KeyDelta<β1, the acquisition frequency needs to be decreased, and the output value is −1; and when β1≤KeyDelta≤β2, the original acquisition frequency remains unchanged, and the output value is 0.

In an embodiment, in order to further improve the accuracy of the frequency conversion direction, for each associated acquisitor group, the frequency conversion direction corresponding to the associated acquisitor group is determined based on the change information of the performance indicator data acquired by the target acquisitor in the associated acquisitor group, and another specific implementation is as follows: determining, for each associated acquisitor group, the frequency conversion direction corresponding to the associated acquisitor group based on the change information of the performance indicator data acquired by the target acquisitor in the associated acquisitor group and a performance analysis result obtained most recently from the performance indicator data acquired by the at least two target acquisitors. Further, in an implementation, for each associated acquisitor group, a first frequency conversion direction corresponding to the associated acquisitor group is determined based on the change information of the performance indicator data acquired by the target acquisitor in the associated acquisitor group, and a second frequency conversion direction corresponding to the associated acquisitor group is determined based on the analysis result obtained most recently from the performance indicator data acquired by the at least two target acquisitors; if the first frequency conversion direction and the second frequency conversion direction are the same, then it is determined that the first frequency conversion direction is the frequency conversion direction corresponding to the associated acquisitor group; and if the first frequency conversion direction and the second frequency conversion direction are different, then the current acquisition frequency should not be adjusted temporarily, first frequency conversion directions in a plurality of statistical intervals can be obtained consecutively through the statistical analysis, and finally the frequency conversion direction corresponding to the associated acquisitor group can be determined based on the first frequency conversion directions in the plurality of consecutive statistical intervals.

It should be noted that in the process of adjusting, for each associated acquisitor group, the acquisition frequency of the target acquisitor in the associated acquisitor group, if a current acquisition frequency of each target acquisitor in the associated acquisitor group is a maximum preset frequency and the frequency conversion direction is frequency-increasing, the current acquisition frequency remains unchanged; and if a current acquisition frequency of each target acquisitor in the associated acquisitor group is a minimum preset frequency and the frequency conversion direction is frequency-decreasing, the current acquisition frequency remains unchanged.

To be noted here, in the present embodiment, at least two local target acquisitors can be grouped for each computing node 102, and target acquisitors are grouped for respective computing nodes 102 according to a same standard. In this way, in units of associated acquisitor groups, the primary node 103 can send a notification message to an else computing node 102 when a frequency conversion direction of a certain associated acquisitor group is frequency-increasing or frequency-decreasing, where the notification message carries therein indication information of frequency-increasing or frequency-decreasing, so that the else computing node 102 can increase or decrease a acquisition frequency of a target acquisitor in a corresponding associated acquisitor group based on the indication information, specifically, it can be increased or decreased to be as the closest preset frequency in the frequency conversion direction. Further, in an implementation, after each computing node 102 divides at least two target acquisitors into at least two associated acquisitor groups, current acquisition frequencies of respective target acquisitors in each associated acquisitor group can be unified in a same way, so that current acquisition frequencies of same associated acquisitor groups in different computing nodes 102 are the same, thereby ensuring that target acquisitors in same associated acquisitor groups in respective computing nodes 102 can be increased or decreased simultaneously, assuring that a same acquisition frequency is used, and guaranteeing that acquisition frequencies of same acquisitors in different computing nodes 102 are consistent, to facilitate the subsequent analysis and processing of the same performance indicator data.

In the foregoing embodiments of the present application, under the computing cluster 100 scenario, an acquisition frequency of performance indicator data is adaptively changed based on change information of the performance indicator data, so that acquisition accuracy can be ensured to guarantee the accuracy of performance analysis based on the performance indicator data and decision-making based on an analysis result, and acquisition overheads can also be reduced. In a process of adaptively changing the acquisition frequency, regarding at least two computing nodes 102 executing a same working task, a primary node 103 among the at least two computing nodes 102 is responsible for adaptive change processing of the acquisition frequency and synchronizing a change to an else computing node 102 when the change is required, and the else computing node 102 is not responsible for the adaptive change processing of the acquisition frequency, so that acquisition overheads of the else computing node 102 can be reduced, thereby further reducing the overall acquisition overheads.

In the foregoing embodiments, descriptions have been made to a situation regarding how a function of acquisition frequency adjustment is achieved by a computing node 102 acting as a primary node 103 when a same working task is deployed in at least two computing nodes 102. In addition, the same working task may also be deployed in one computing node 102, in this case, there is no need to select the primary node 103, and the computing node 102 executing the working task may adjust acquisition frequencies of local target acquisitors initiatively in the following manner which specifically includes: initiating, during execution of a working task, at least two target acquisitors correlated with the working task, to enable the at least two target acquisitors to acquire, at current acquisition frequencies, at least two types of performance indicator data of a computing node in which they are located; dividing the at least two target acquisitors into at least two associated acquisitor groups based on an association of performance indicators that the at least two target acquisitors are responsible for acquiring; separately adjusting an acquisition frequency of a target acquisitor in each associated acquisitor group based on change information of performance indicator data acquired by the target acquisitor in each associated acquisitor group, to enable target acquisitors in each associated acquisitor group to proceed with acquiring, at an adjusted acquisition frequency, the at least two types of performance indicator data of the computing node in which they are located. For detailed implementation of each step, reference can be made to descriptions of the foregoing embodiments, and details will not be described here again.

FIG. 2 is a schematic flowchart of a data acquisition method for a computing cluster 100 according to an exemplary embodiment of the present application. As shown in FIG. 2, the method includes:
201, initiating at least two target acquisitors correlated with a working task during execution of the working task, to enable the at least two target acquisitors to acquire, at current acquisition frequencies, at least two types of performance indicator data of a computing node in which they are located, where the working task is deployed in at least two computing nodes in the computing cluster 100;
202, adjusting the acquisition frequencies of the at least two target acquisitors based on change information of the at least two types of performance indicator data when determining that the computing node itself is a primary node in the at least two computing nodes;
203, notifying an else computing node of the at least two computing nodes to adjust acquisition frequencies of at least two target acquisitors deployed in the else computing node, to enable the at least two target acquisitors in the else computing node to proceed with acquiring, at an adjusted acquisition frequency, the at least two types of performance indicator data of the computing node in which they are located.

In the present embodiment, the adjusting the acquisition frequencies of the at least two target acquisitors based on the change information of the at least two types of performance indicator data includes: dividing the at least two target acquisitors into at least two associated acquisitor groups based on an association of performance indicators that the at least two target acquisitors are responsible for acquiring; separately adjusting an acquisition frequency of a target acquisitor in each associated acquisitor group based on change information of performance indicator data acquired by the target acquisitor in each associated acquisitor group.

In an embodiment, the separately adjusting the acquisition frequency of the target acquisitor in each associated acquisitor group based on the change information of the performance indicator data acquired by the target acquisitor in each associated acquisitor group includes: determining, for each associated acquisitor group, a frequency conversion direction corresponding to the associated acquisitor group based on the change information of the performance indicator data acquired by the target acquisitor in the associated acquisitor group; adjusting the acquisition frequency currently used by the target acquisitor in the associated acquisitor group to a closest preset frequency of a plurality of preset frequencies in the frequency conversion direction, where the plurality of preset frequencies are from small to large.

Further, in an implementation, in a process of adjusting, for each associated acquisitor group, the acquisition frequency of the target acquisitor in the associated acquisitor group, the method further includes: if a current acquisition frequency of each target acquisitor in the associated acquisitor group is a maximum preset frequency and the frequency conversion direction is frequency-increasing, remaining the current acquisition frequency unchanged; if a current acquisition frequency of each target acquisitor in the associated acquisitor group is a minimum preset frequency and the frequency conversion direction is frequency-decreasing, remaining the current acquisition frequency unchanged.

Further, in an implementation, before determining, for each associated target acquisitor group, the frequency conversion direction corresponding to the associated acquisitor group based on the change information of the performance indicator data acquired by the target acquisitor in the associated acquisitor group, the method further includes: for each associated acquisitor group, if current acquisition frequencies of respective target acquisitors in the associated acquisitor group are different, adjusting the current acquisition frequencies of the respective target acquisitors in the associated acquisitor group to a same acquisition frequency.

In an embodiment, the adjusting the current acquisition frequencies of the respective target acquisitors in the associated acquisitor group to the same acquisition frequency includes: adjusting each of the current acquisition frequencies of the respective target acquisitors in the associated acquisitor group to an average value of the current acquisition frequencies of the respective target acquisitors in the associated acquisitor group; or adjusting each of the current acquisition frequencies of the respective target acquisitors in the associated acquisitor group to a maximum acquisition frequency among the current acquisition frequencies of the respective target acquisitors in the associated acquisitor group; or adjusting each of the current acquisition frequencies of the respective target acquisitors in the associated target acquisitor to a minimum acquisition frequency among the current acquisition frequencies of the respective target acquisitors in the associated acquisitor group.

In an embodiment, the determining, for each associated acquisitor group, the frequency conversion direction corresponding to the associated acquisitor group based on the change information of the performance indicator data acquired by the target acquisitor in the associated acquisitor group includes: acquiring, for each associated acquisitor group, key performance indicator data acquired by a key acquisitor in the associated acquisitor group, where the key acquisitor is a target acquisitor responsible for acquiring a key performance indicator; performing a statistical analysis on change rates of respective pieces of key performance indicator data based on a set statistical interval, and generating a global change rate based on the change rates of the respective pieces of key performance indicator data; and determining the frequency conversion direction corresponding to the associated acquisitor group based on the global change rate, where the frequency conversion direction includes any one of frequency-increasing, frequency-decreasing and frequency-remaining-unchanged.

In an embodiment, the determining, for each associated acquisitor group, the frequency conversion direction corresponding to the associated acquisitor group based on the change information of the performance indicator data acquired by the target acquisitor in the associated acquisitor group includes: determining, for each associated acquisitor group, the frequency conversion direction corresponding to the associated acquisitor group, based on the change information of the performance indicator data acquired by the target acquisitor in the associated acquisitor group and a performance analysis result obtained most recently from the performance indicator data acquired by the at least two target acquisitors.

To be noted here, reference can be made to corresponding contents in the foregoing embodiments of the computing cluster 100 for specific implementation principles of steps of the data acquisition method in the computing cluster 100 according to the present embodiment, and details will not be described here again.

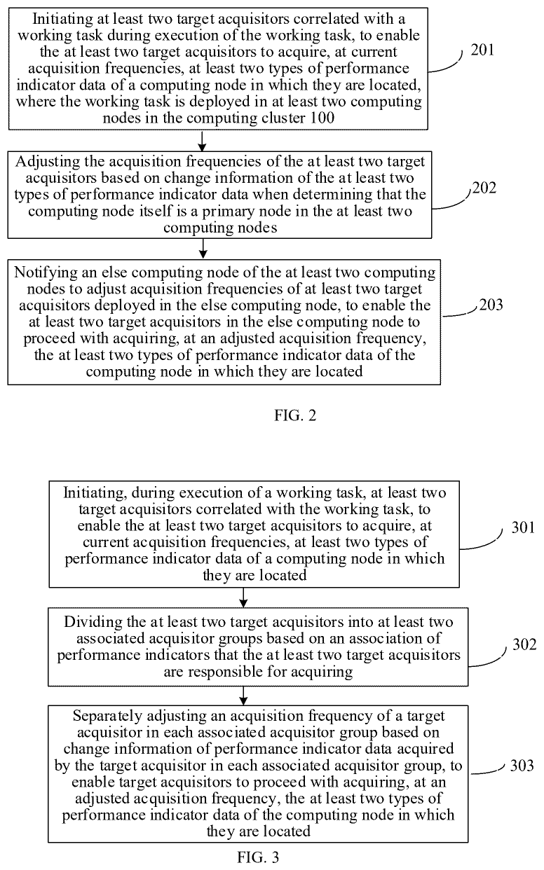

FIG. 3 is a schematic flowchart of another data acquisition method for a computing cluster 100 according to an exemplary embodiment of the present application. As shown in FIG. 3, where the method includes:
301, initiating, during execution of a working task, at least two target acquisitors correlated with the working task, to enable the at least two target acquisitors to acquire, at current acquisition frequencies, at least two types of performance indicator data of a computing node in which they are located;
302, dividing the at least two target acquisitors into at least two associated acquisitor groups based on an association of performance indicators that the at least two target acquisitors are responsible for acquiring;
303, separately adjusting an acquisition frequency of a target acquisitor in each associated acquisitor group based on change information of performance indicator data acquired by the target acquisitor in each associated acquisitor group, to enable target acquisitors to proceed with acquiring, at an adjusted acquisition frequency, the at least two types of performance indicator data of the computing node in which they are located.

To be noted here, reference can be made to corresponding contents in the foregoing embodiments of the computing cluster 100 for specific implementation principles of steps of the data acquisition method in the computing cluster 100 according to the present embodiment, and details will not be described here again.

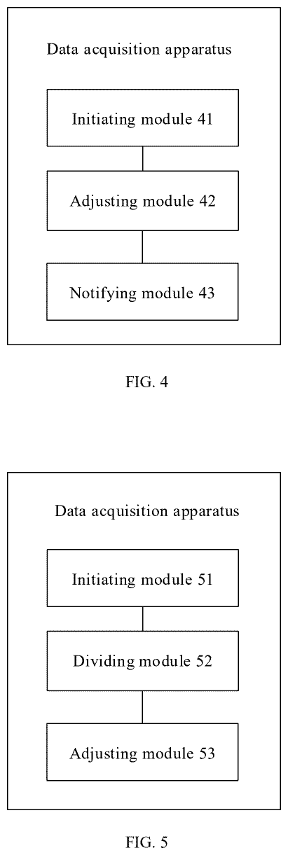

FIG. 4 is a schematic structural diagram of a data acquisition apparatus according to an exemplary embodiment of the present application. As shown in FIG. 4, the apparatus includes:
an initiating module 41, configured to initiate, during execution of a working task, at least two target acquisitors correlated with the working task, to enable the at least two target acquisitors to acquire, at current acquisition frequencies, at least two types of performance indicator data of a computing node in which they are located, where the working task is deployed in at least two computing nodes in the computing cluster 100;
an adjusting module 42, configured to adjust the acquisition frequencies of the at least two target acquisitors based on change information of the at least two types of performance indicator data when determining that the computing node itself is a primary node in the at least two computing nodes;
a notifying module 43, configured to notify an else computing node of the at least two computing nodes to adjust acquisition frequencies of at least two target acquisitors deployed in the else computing node, to enable the at least two target acquisitors in the else computing node to proceed with acquiring, at an adjusted acquisition frequency, the at least two types of performance indicator data of the computing node in which they are located.

In an embodiment, when adjusting the acquisition frequencies of the at least two target acquisitors based on the change information of the at least two types of performance indicator data, the adjusting module 42 is specifically configured to: divide the at least two target acquisitors into at least two associated acquisitor groups based on an association of performance indicators that the at least two target acquisitors are responsible for acquiring; separately adjust an acquisition frequency of a target acquisitor in each associated acquisitor group based on change information of performance indicator data acquired by the target acquisitor in each associated acquisitor group.

In an embodiment, when separately adjusting the acquisition frequency of the target acquisitor in each associated acquisitor group based on the change information of the performance indicator data acquired by the target acquisitor in each associated acquisitor group, the adjusting module 42 is specifically configured to: determine, for each associated acquisitor group, a frequency conversion direction corresponding to the associated acquisitor group based on the change information of the performance indicator data acquired by the target acquisitor in the associated acquisitor group; and adjust the acquisition frequency currently used by the target acquisitor in the associated acquisitor group to a closest preset frequency of a plurality of preset frequencies in the frequency conversion direction, where the plurality of preset frequencies are from small to large.

Further, in an implementation, when in a process of adjusting, for each associated acquisitor group, the acquisition frequency of the target acquisitor in the associated acquisitor group, the adjusting module 42 is further configured to: if a current acquisition frequency of each target acquisitor in the associated acquisitor group is a maximum preset frequency and the frequency conversion direction is frequency-increasing, remain the current acquisition frequency unchanged; and if a current acquisition frequency of each target acquisitor in the associated acquisitor group is a minimum preset frequency and the frequency conversion direction is frequency-decreasing, remain the current acquisition frequency unchanged.

Further, in an implementation, before determining, for each associated target acquisitor group, the frequency conversion direction corresponding to the associated acquisitor group based on the change information of the performance indicator data acquired by the target acquisitor in the associated acquisitor group, the adjusting module 42 is further configured to: for each associated acquisitor group, if current acquisition frequencies of respective target acquisitors in the associated acquisitor group are different, adjust the current acquisition frequencies of the respective target acquisitors in the associated acquisitor group to a same acquisition frequency.

In an embodiment, when adjusting the current acquisition frequencies of the respective target acquisitors in the associated acquisitor group to the same acquisition frequency, the adjusting module 42 is specifically configured to: adjust each of the current acquisition frequencies of the respective target acquisitors in the associated acquisitor group to an average value of the current acquisition frequencies of the respective target acquisitors in the associated acquisitor group; or adjust each of the current acquisition frequencies of the respective target acquisitors in the associated acquisitor group to a maximum acquisition frequency among the current acquisition frequencies of the respective target acquisitors in the associated acquisitor group; or adjust each of the current acquisition frequencies of the respective target acquisitors in the associated target acquisitor to a minimum acquisition frequency among the current acquisition frequencies of the respective target acquisitors in the associated acquisitor group.

In an embodiment, when determining, for each associated acquisitor group, the frequency conversion direction corresponding to the associated acquisitor group based on the change information of the performance indicator data acquired by the target acquisitor in the associated acquisitor group, the adjusting module 42 is specifically configured to: acquire, for each associated acquisitor group, key performance indicator data acquired by a key acquisitor in the associated acquisitor group, where the key acquisitor is a target acquisitor responsible for acquiring a key performance indicator; perform a statistical analysis on change rates of respective pieces of key performance indicator data based on a set statistical interval, and generate a global change rate based on the change rates of the respective pieces of key performance indicator data; and determine the frequency conversion direction corresponding to the associated acquisitor group based on the global change rate, where the frequency conversion direction includes any one of frequency-increasing, frequency-decreasing and frequency-remaining-unchanged.

In an embodiment, when determining, for each associated acquisitor group, the frequency conversion direction corresponding to the associated acquisitor group based on the change information of the performance indicator data acquired by the target acquisitor in the associated acquisitor group, the adjusting module 42 is specifically configured to: determine, for each associated acquisitor group, the frequency conversion direction corresponding to the associated acquisitor group, based on the change information of the performance indicator data acquired by the target acquisitor in the associated acquisitor group and a performance analysis result obtained most recently from the performance indicator data acquired by the at least two target acquisitors.

To be noted here, the data acquisition apparatus provided in the present embodiment can implement the technical solutions described in the method embodiments of FIG. 2. Reference can be made to corresponding contents in the foregoing embodiments of the computing cluster 100 shown in FIG. 1a and the method shown in FIG. 2 for specific implementation principles of the foregoing modules or units, and details will not be described here again.

FIG. 5 is a schematic structural diagram of another data acquisition apparatus according to an exemplary embodiment of the present application. As shown in FIG. 5, the apparatus includes:
an initiating module 51, configured to initiate, during execution of a working task, at least two target acquisitors correlated with the working task, to enable the at least two target acquisitors to acquire, at current acquisition frequencies, at least two types of performance indicator data of a computing node in which they are located;
a dividing module 52, configured to divide the at least two target acquisitors into at least two associated acquisitor groups based on an association of performance indicators that the at least two target acquisitors are responsible for acquiring;
an adjusting module 53, configured to separately adjust an acquisition frequency of a target acquisitor in each associated acquisitor group based on change information of performance indicator data acquired by the target acquisitor in each associated acquisitor group, to enable target acquisitors to proceed with acquiring, at an adjusted acquisition frequency, the at least two types of performance indicator data of the computing node in which they are located.

To be noted here, the data acquisition apparatus provided in the present embodiment can implement the technical solutions described in the method embodiments of FIG. 3. Reference can be made to corresponding contents in the foregoing embodiments of the computing cluster 100 shown in FIG. 1a and the method shown in FIG. 3 for specific implementation principles of the foregoing modules or units, and details will not be described here again.

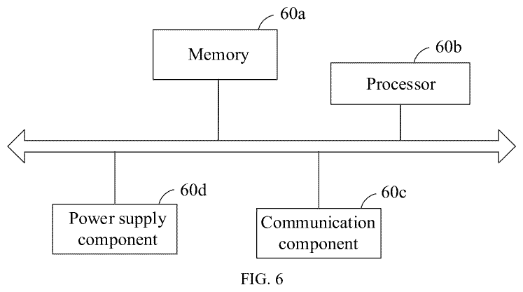

FIG. 6 is a schematic structural diagram of a computing node according to an exemplary embodiment of the present application. The computing node can be used as any computing node in the aforementioned computing cluster 100, as shown in FIG. 6. The computing node includes: a memory 60a and a processor 60b; where the memory 60a is configured to store a computer program, and the processor 60b, coupled with the memory 60a, is configured to execute the computer program for:
initiating, during execution of a working task, at least two target acquisitors correlated with the working task, to enable the at least two target acquisitors to acquire, at current acquisition frequencies, at least two types of performance indicator data of the computing node in which they are located, where the working task is deployed in at least two computing nodes in the computing cluster 100;
adjusting the acquisition frequencies of the at least two target acquisitors based on change information of the at least two types of performance indicator data when determining that the computing node itself is a primary node in the at least two computing nodes;
notifying an else computing node of the at least two computing nodes to adjust acquisition frequencies of at least two target acquisitors deployed in the else computing node, to enable the at least two target acquisitors in the else computing node to proceed with acquiring, at an adjusted acquisition frequency, the at least two types of performance indicator data of the computing node in which they are located.

In an embodiment, when adjusting the acquisition frequencies of the at least two target acquisitors based on the change information of the at least two types of performance indicator data, the processor 60b is specifically configured to: divide the at least two target acquisitors into at least two associated acquisitor groups based on an association of performance indicators that the at least two target acquisitors are responsible for acquiring; separately adjust an acquisition frequency of a target acquisitor in each associated acquisitor group based on change information of performance indicator data acquired by the target acquisitor in each associated acquisitor group.

In an embodiment, when separately adjusting the acquisition frequency of the target acquisitor in each associated acquisitor group based on the change information of the performance indicator data acquired by the target acquisitor in each associated acquisitor group, the processor 60b is specifically configured to: determine, for each associated acquisitor group, a frequency conversion direction corresponding to the associated acquisitor group based on the change information of the performance indicator data acquired by the target acquisitor in the associated acquisitor group; adjust the acquisition frequency currently used by the target acquisitor in the associated acquisitor group to a closest preset frequency of a plurality of preset frequencies in the frequency conversion direction, where the plurality of preset frequencies are from small to large.

In an embodiment, when in a process of adjusting, for each associated acquisitor group, the acquisition frequency of the target acquisitor in the associated acquisitor group, the processor 60b is further configured to: if a current acquisition frequency of each target acquisitor in the associated acquisitor group is a maximum preset frequency and the frequency conversion direction is frequency-increasing, remain the current acquisition frequency unchanged; if a current acquisition frequency of each target acquisitor in the associated acquisitor group is a minimum preset frequency and the frequency conversion direction is frequency-decreasing, remain the current acquisition frequency unchanged.

In an embodiment, before determining, for each associated target acquisitor group, the frequency conversion direction corresponding to the associated acquisitor group based on the change information of the performance indicator data acquired by the target acquisitor in the associated acquisitor group, the processor 60b is further configured to: for each associated acquisitor group, if current acquisition frequencies of respective target acquisitors in the associated acquisitor group are different, adjust the current acquisition frequencies of the respective target acquisitors in the associated acquisitor group to a same acquisition frequency.

In an embodiment, when adjusting the current acquisition frequencies of the respective target acquisitors in the associated acquisitor group to the same acquisition frequency, the processor 60b is specifically configured to: adjust each of the current acquisition frequencies of the respective target acquisitors in the associated acquisitor group to an average value of the current acquisition frequencies of the respective target acquisitors in the associated acquisitor group; or adjust each of the current acquisition frequencies of the respective target acquisitors in the associated acquisitor group to a maximum acquisition frequency among the current acquisition frequencies of the respective target acquisitors in the associated acquisitor group; or adjust each of the current acquisition frequencies of the respective target acquisitors in the associated target acquisitor to a minimum acquisition frequency among the current acquisition frequencies of the respective target acquisitors in the associated acquisitor group.

In an embodiment, when determining, for each associated acquisitor group, the frequency conversion direction corresponding to the associated acquisitor group based on the change information of the performance indicator data acquired by the target acquisitor in the associated acquisitor group, the processor 60b is specifically configured to: acquire, for each associated acquisitor group, key performance indicator data acquired by a key acquisitor in the associated acquisitor group, where the key acquisitor is a target acquisitor responsible for acquiring a key performance indicator; perform a statistical analysis on change rates of respective pieces of key performance indicator data based on a set statistical interval, and generate a global change rate based on the change rates of the respective pieces of key performance indicator data; and determine the frequency conversion direction corresponding to the associated acquisitor group based on the global change rate, where the frequency conversion direction includes any one of frequency-increasing, frequency-decreasing and frequency-remaining-unchanged.

In an embodiment, when determining, for each associated acquisitor group, the frequency conversion direction corresponding to the associated acquisitor group based on the change information of the performance indicator data acquired by the target acquisitor in the associated acquisitor group, the processor 60b is specifically configured to: determine, for each associated acquisitor group, the frequency conversion direction corresponding to the associated acquisitor group, based on the change information of the performance indicator data acquired by the target acquisitor in the associated acquisitor group and a performance analysis result obtained most recently from the performance indicator data acquired by the at least two target acquisitors.

In the foregoing embodiments, descriptions have been made to a situation regarding how a function of acquisition frequency adjustment is achieved by a computing node acting as a primary node when a same working task is deployed in at least two computing nodes. In addition, the same working task may also be deployed in one computing node, in this case, there is no need to select the primary node, and the processor 60b of the computing node executing the working task may also perform operations of:
initiating, during execution of a working task, at least two target acquisitors correlated with the working task, to enable the at least two target acquisitors to acquire, at current acquisition frequencies, at least two types of performance indicator data of a computing node in which they are located;
dividing the at least two target acquisitors into at least two associated acquisitor groups based on an association of performance indicators that the at least two target acquisitors are responsible for acquiring;
separately adjusting an acquisition frequency of a target acquisitor in each associated acquisitor group based on change information of performance indicator data acquired by the target acquisitor in each associated acquisitor group, to enable target acquisitors to proceed with acquiring, at an adjusted acquisition frequency, the at least two types of performance indicator data of the computing node in which they are located.

Furthermore, as shown in FIG. 6, the electronic device also includes other components such as a communication component 60c, a power supply component 60d, etc. FIG. 6 just schematically illustrates some components, which does not mean that the electronic device only includes the components shown in FIG. 6.

To be noted here, the computing node provided in the present embodiment can implement the technical solutions described in the method embodiments of FIG. 2 or FIG. 3. Reference can be made to corresponding contents in the foregoing embodiments of the computing cluster 100 shown in FIG. 1a for specific implementation principles of the foregoing modules or units, and details will not be described here again.

An exemplary embodiment of the present application provides a computer-readable storage medium storing a computer program/instruction, where the computer program/instruction, when executed by a processor, causes the processor to implement steps of the methods described above, and details will not be described here again.

An exemplary embodiment of the present application provides a computer program product including a computer program/instruction, where the computer program/instruction, when executed by a processor, causes the processor to implement steps of the methods described above, and details will not be described here again.

The communication components in the foregoing embodiments are configured to facilitate wired or wireless communication between a node where the communication component is located and an else node. The node where the communication component is located may access a wireless network that is based on a communication standard, such as a mobile communication network like WiFi, 2G, 3G, 4G/LTE, 5G, or a combination thereof. In an exemplary embodiment, the communication component receives broadcast signals or broadcast-related information from an external broadcast management system via a broadcast channel. In an exemplary embodiment, the communication component further includes a near field communication (NFC) module to facilitate short-range communication. For example, the NFC module can be implemented based on a radio frequency identification (RFID) technology, an infrared data association (IrDA) technology, an ultra wideband (UWB) technology, a Bluetooth (BT) technology and other technologies.

A display in the foregoing embodiments includes a screen, and the screen may include a liquid crystal display (LCD) and a touch panel (TP). If the screen includes a touch panel, the screen may be implemented as a touch screen to receive an input signal from a user. The touch panel includes one or more touch sensors to sense a touch, a swipe and a gesture on the touch panel. The touch sensor may not only sense a boundary of a touch or a swipe action, but also detect a duration and a pressure associated with the touch or the swipe action.

The power supply component in the foregoing embodiments provides power for various components of a node where the power supply component is located. The power supply component may include a power supply management system, one or more power supplies, and other components associated with power generation, management and distribution for the node where the power supply component is located.

An audio component in the foregoing embodiments may be configured to output and/or input an audio signal. For example, the audio component includes a microphone (MIC), and when a node where the audio component is located resides in an operation mode, such as a call mode, a recording mode and a voice recognition mode, the microphone is configured to receive an external audio signal. The received audio signal may be further stored in a memory or be transmitted via the communication component. In some embodiments, the audio component further includes a speaker configured to output the audio signal.

Those skilled in the art should understand that the embodiments of the present application may be provided as methods, systems, or computer program products. Accordingly, the present application may take the form of hardware embodiments entirely, software embodiments entirely, or a combination of software and hardware embodiments. Further, the present application may take the form of a computer program product implemented in one or more computer-usable storage media (including but not limited to disk memories, CD-ROMs, optical memories, etc.) containing computer-usable program codes.

The present application is described with reference to flow charts and/or block diagrams of methods, nodes (systems) and computer program products according to embodiments of the present application. It will be appreciated that computer programming instructions can implement each flow and/or block in the flow charts and/or the block diagrams, and a combination of a flow and/or a block in the flow charts and/or the block diagrams. These computer programming instructions may be provided to a processor of a general purpose computer, a special purpose computer, an embedded processor or other programmable data processing node to generate a machine, so that the instructions executed by the processor of the computer or the other programmable data processing node generate a device for performing functions specified in one or more flows of the flow charts and/or one or more blocks of the block diagrams.

These computer programing instructions may also be stored in a computer-readable memory capable of directing the computer or other programmable data processing node to operate in a specific manner, so that the instructions stored in the computer-readable memory generate a manufactured product including an instruction device, where the instruction device implements functions specified in one or more flows of the flow charts and/or one or more blocks of the block diagrams.

These computer programing instructions may also be loaded in the computer or the other programmable data processing node, so that a series of operation steps are performed in the computer or the other programmable data processing node to generate a computer implemented process, and thus the instructions executed in the computer or the other programmable data processing node provide steps for implementing the functions specified in one or more flows of the flow charts and/or one or more blocks of the block diagrams.

In a typical configuration, the computing node includes one or more processors (CPU), input/output interfaces, network interfaces, and memories.

The memories may include forms such as a non-persistent memory in a computer-readable medium, a random access memory (RAM), and/or a non-volatile memory, such as a read-only memory (ROM) or a flash memory (flash RAM). The memories are examples of computer-readable media.

The computer-readable media include permanent and non-permanent, removable and non-removable media, and information storage can be achieved by any method or technology. Information can be computer-readable instructions, data structures, program modules, or other data. Examples of the storage media for computers include, but are not limited to, phase-change random access memories (PRAM), static random access memories (SRAM), dynamic random access memories (DRAM), other types of random access memories (RAM), read-only memories (ROM), electrically erasable programmable read-only memories (EEPROM), flash memories or other memory technologies, compact disc read-only memories (CD-ROM), digital versatile discs (DVD) or other optical storages, magnetic cassette tapes, magnetic tape and disk storages, or other magnetic storage nodes, or any other non-transport media, available for storing information accessible by the computing node. As defined in the present application, the computer-readable media do not include transitory computer-readable media (transitory media), such as modulated data signals and carriers.

It should also be noted that the term “include”, “contain” or any other variation thereof is intended to cover non-exclusive inclusion, so that a process, a method, an article or a node including a series of elements not only includes those elements, but also includes other elements that are non-explicitly listed or elements that are inherent to such process, method, article or node. In the absence of further restrictions, an element defined by the phrase “including a . . . ” does not preclude the existence of other identical elements in the process, the method, the article or the node including the element.

The above descriptions are merely embodiments of the present application, and are not intended to limit the present application. For those skilled in the art, the present application may have various modifications and changes. Any modification, equivalent replacement, improvement and the like made within the spirit and principle of the present application shall be included in the scope of the claims of the present application.

1. A computing cluster, comprising: a management and control node and a plurality of computing nodes, wherein each computing node is deployed with a plurality of acquisitors, and different acquisitors are configured to acquire different performance indicators;
the management and control node is configured to deploy a same working task on at least two computing nodes of the plurality of computing nodes and control the at least two computing nodes to execute the working task;
each computing node is configured to initiate at least two target acquisitors correlated with the working task during execution of the working task, to enable the at least two target acquisitors to acquire, at current acquisition frequencies, at least two types of performance indicator data of the computing node in which the at least two target acquisitors are located;
when determining that the computing node itself is a primary node in the at least two computing nodes, adjust the acquisition frequencies of the at least two target acquisitors based on change information of the at least two types of performance indicator data;
notify an else computing node of the at least two computing nodes to adjust acquisition frequencies of at least two target acquisitors in the else computing node, to enable the at least two target acquisitors in the else computing node to proceed acquiring, at an adjusted acquisition frequency, the at least two types of performance indicator data of the computing node in which the at least two target acquisitors are located.

2. A data acquisition method for a computing cluster, applied to any computing node in the computing cluster, the method comprising:
initiating, during execution of a working task, at least two target acquisitors correlated with the working task, to enable the at least two target acquisitors to acquire, at current acquisition frequencies, at least two types of performance indicator data of a computing node in which the at least two target acquisitors are located, wherein the working task is deployed in at least two computing nodes in the computing cluster;
adjusting the acquisition frequencies of the at least two target acquisitors based on change information of the at least two types of performance indicator data when determining that the computing node itself is a primary node in the at least two computing nodes;
notifying an else computing node of the at least two computing nodes to adjust acquisition frequencies of at least two target acquisitors deployed in the else computing node, to enable the at least two target acquisitors in the else computing node to proceed acquiring, at an adjusted acquisition frequency, the at least two types of performance indicator data of the computing node in which the at least two target acquisitors are located.

3. The method according to claim 2, wherein the adjusting the acquisition frequencies of the at least two target acquisitors based on the change information of the at least two types of performance indicator data comprises:
dividing the at least two target acquisitors into at least two associated acquisitor groups based on an association of performance indicators that the at least two target acquisitors are responsible for acquiring;
separately adjusting an acquisition frequency of a target acquisitor in each associated acquisitor group based on change information of performance indicator data acquired by the target acquisitor in each associated acquisitor group.

4. The method according to claim 3, wherein the separately adjusting the acquisition frequency of the target acquisitor in each associated acquisitor group based on the change information of the performance indicator data acquired by the target acquisitor in each associated acquisitor group comprises:
determining, for each associated acquisitor group, a frequency conversion direction corresponding to the associated acquisitor group based on the change information of the performance indicator data acquired by the target acquisitor in the associated acquisitor group;
adjusting the acquisition frequency currently used by the target acquisitor in the associated acquisitor group to a closest preset frequency of a plurality of preset frequencies in the frequency conversion direction, wherein the plurality of preset frequencies are from small to large.

5. The method according to claim 4, for each associated acquisitor group, in a process of adjusting the acquisition frequency of the target acquisitor in the associated acquisitor group, further comprising:
based on that a current acquisition frequency of each target acquisitor in the associated acquisitor group is a maximum preset frequency and the frequency conversion direction is frequency-increasing, remaining the current acquisition frequency unchanged;
based on that a current acquisition frequency of each target acquisitor in the associated acquisitor group is a minimum preset frequency and the frequency conversion direction is frequency-decreasing, remaining the current acquisition frequency unchanged.

6. The method according to claim 4, before determining, for each associated target acquisitor group, the frequency conversion direction corresponding to the associated acquisitor group based on the change information of the performance indicator data acquired by the target acquisitor in the associated acquisitor group, further comprising:
for each associated acquisitor group, based on that the current acquisition frequencies of respective target acquisitors in the associated acquisitor group are different, adjusting the current acquisition frequencies of the respective target acquisitors in the associated acquisitor group to a same acquisition frequency.

7. The method according to claim 6, wherein the adjusting the current acquisition frequencies of the respective target acquisitors in the associated acquisitor group to the same acquisition frequency comprises:
adjusting each of the current acquisition frequencies of the respective target acquisitors in the associated acquisitor group to an average value of the current acquisition frequencies of the respective target acquisitors in the associated acquisitor group;
or
adjusting each of the current acquisition frequencies of the respective target acquisitors in the associated acquisitor group to a maximum acquisition frequency among the current acquisition frequencies of the respective target acquisitors in the associated acquisitor group;
or
adjusting each of the current acquisition frequencies of the respective target acquisitors in the associated target acquisitor to a minimum acquisition frequency among the current acquisition frequencies of the respective target acquisitors in the associated acquisitor group.

8. The method according to claim 4, wherein the determining, for each associated acquisitor group, the frequency conversion direction corresponding to the associated acquisitor group based on the change information of the performance indicator data acquired by the target acquisitor in the associated acquisitor group comprises:
acquiring, for each associated acquisitor group, key performance indicator data acquired by a key acquisitor in the associated acquisitor group, wherein the key acquisitor is a target acquisitor responsible for acquiring a key performance indicator;
performing a statistical analysis on change rates of respective pieces of key performance indicator data based on a set statistical interval, and generating a global change rate based on the change rates of the respective pieces of key performance indicator data;
determining the frequency conversion direction corresponding to the associated acquisitor group based on the global change rate, wherein the frequency conversion direction comprises any one of frequency-increasing, frequency-decreasing and frequency-remaining-unchanged.

9. The method according to claim 4, wherein the determining, for each associated acquisitor group, the frequency conversion direction corresponding to the associated acquisitor group based on the change information of the performance indicator data acquired by the target acquisitor in the associated acquisitor group comprises:
determining, for each associated acquisitor group, the frequency conversion direction corresponding to the associated acquisitor group, based on the change information of the performance indicator data acquired by the target acquisitor in the associated acquisitor group and a performance analysis result obtained most recently from the performance indicator data acquired by the at least two target acquisitors.

10. A data acquisition method for a computing cluster, applied to any computing node in the computing cluster, the method comprising:
initiating, during execution of a working task, at least two target acquisitors correlated with the working task, to enable the at least two target acquisitors to acquire, at current acquisition frequencies, at least two types of performance indicator data of a computing node in which the at least two target acquisitors are located;
dividing the at least two target acquisitors into at least two associated acquisitor groups based on an association of performance indicators that the at least two target acquisitors are responsible for acquiring;
separately adjusting an acquisition frequency of a target acquisitor in each associated acquisitor group based on change information of performance indicator data acquired by the target acquisitor in each associated acquisitor group, to enable target acquisitors to proceed with acquiring, at an adjusted acquisition frequency, the at least two types of performance indicator data of the computing node in which the at least two target acquisitors are located.

11. (canceled)

12. (canceled)

13. A computing node, applied to a computing cluster, the computing node comprising: a memory and a processor; wherein the memory is configured to store a computer program; and the processor, coupled with the memory, is configured to execute the computer program for performing steps of the method in claim 2.

14. A non-transitory computer-readable storage medium, storing a computer program which, when executed by a processor, causes the processor to implement steps of the method in claim 2.

15. The method according to claim 10, wherein the separately adjusting the acquisition frequency of the target acquisitor in each associated acquisitor group based on the change information of the performance indicator data acquired by the target acquisitor in each associated acquisitor group comprises:
determining, for each associated acquisitor group, a frequency conversion direction corresponding to the associated acquisitor group based on the change information of the performance indicator data acquired by the target acquisitor in the associated acquisitor group;
adjusting the acquisition frequency currently used by the target acquisitor in the associated acquisitor group to a closest preset frequency of a plurality of preset frequencies in the frequency conversion direction, wherein the plurality of preset frequencies are from small to large.

16. The method according to claim 15, for each associated acquisitor group, in a process of adjusting the acquisition frequency of the target acquisitor in the associated acquisitor group, further comprising:
based on that a current acquisition frequency of each target acquisitor in the associated acquisitor group is a maximum preset frequency and the frequency conversion direction is frequency-increasing, remaining the current acquisition frequency unchanged;
based on that a current acquisition frequency of each target acquisitor in the associated acquisitor group is a minimum preset frequency and the frequency conversion direction is frequency-decreasing, remaining the current acquisition frequency unchanged.

17. The method according to claim 15, before determining, for each associated target acquisitor group, the frequency conversion direction corresponding to the associated acquisitor group based on the change information of the performance indicator data acquired by the target acquisitor in the associated acquisitor group, further comprising:
for each associated acquisitor group, based on that the current acquisition frequencies of respective target acquisitors in the associated acquisitor group are different, adjusting the current acquisition frequencies of the respective target acquisitors in the associated acquisitor group to a same acquisition frequency.

18. The method according to claim 17, wherein the adjusting the current acquisition frequencies of the respective target acquisitors in the associated acquisitor group to the same acquisition frequency comprises:
adjusting each of the current acquisition frequencies of the respective target acquisitors in the associated acquisitor group to an average value of the current acquisition frequencies of the respective target acquisitors in the associated acquisitor group;
or
adjusting each of the current acquisition frequencies of the respective target acquisitors in the associated acquisitor group to a maximum acquisition frequency among the current acquisition frequencies of the respective target acquisitors in the associated acquisitor group;
or
adjusting each of the current acquisition frequencies of the respective target acquisitors in the associated target acquisitor to a minimum acquisition frequency among the current acquisition frequencies of the respective target acquisitors in the associated acquisitor group.

19. The method according to claim 15, wherein the determining, for each associated acquisitor group, the frequency conversion direction corresponding to the associated acquisitor group based on the change information of the performance indicator data acquired by the target acquisitor in the associated acquisitor group comprises:
acquiring, for each associated acquisitor group, key performance indicator data acquired by a key acquisitor in the associated acquisitor group, wherein the key acquisitor is a target acquisitor responsible for acquiring a key performance indicator;
performing a statistical analysis on change rates of respective pieces of key performance indicator data based on a set statistical interval, and generating a global change rate based on the change rates of the respective pieces of key performance indicator data;
determining the frequency conversion direction corresponding to the associated acquisitor group based on the global change rate, wherein the frequency conversion direction comprises any one of frequency-increasing, frequency-decreasing and frequency-remaining-unchanged.

20. The method according to claim 15, wherein the determining, for each associated acquisitor group, the frequency conversion direction corresponding to the associated acquisitor group based on the change information of the performance indicator data acquired by the target acquisitor in the associated acquisitor group comprises:
determining, for each associated acquisitor group, the frequency conversion direction corresponding to the associated acquisitor group, based on the change information of the performance indicator data acquired by the target acquisitor in the associated acquisitor group and a performance analysis result obtained most recently from the performance indicator data acquired by the at least two target acquisitors.

21. A computing node, applied to a computing cluster, the computing node comprising: a memory and a processor; wherein the memory is configured to store a computer program; and the processor, coupled with the memory, is configured to execute the computer program for performing steps of the method in claim 10.

22. A non-transitory computer-readable storage medium, storing a computer program which, when executed by a processor, causes the processor to implement steps of the method in claim 10.
